(19) United States
(12) Patent Application Publication
(10) Pub. No.: US 2008/0319958 A1
(43) Pub. Date: Dec. 25, 2008

(54) Dynamic Metadata based Query Formulation for Multiple Heterogeneous Database Systems

(76) Inventors: Sutirtha Bhattacharya, Hillsboro, OR (US); Ashraf Wadaa, Beaverton, OR (US); Luis Cepeda, Hillsboro, OR (US)

Correspondence Address: BUCKLEY, MASCHOFF & TALWALKAR LLC, 50 LOCUST AVENUE, NEW CANAAN, CT, 06840, US

(21) Appl. No.: 11/766,894

(22) Filed: Jun. 22, 2007

(51) Int. Cl. G06F 17/30

(52) U.S. Cl. 707/4

(57) ABSTRACT

A method may comprise receiving a template query and one or more keywords from a user, generating a SQL query specification based on the template query and the one or more keywords, formulating SQL code based on metadata specification, sending the SQL code to a query execution engine, receiving correlated query results from multiple physical databases and providing the query result to the user.

### BACKGROUND

A database may store data within logically-related tables. Queries may be used to access the stored data. Structured query language (“SQL”) is a common query language supported by many database systems.

To write an SQL for accessing a database, a user must have knowledge of the database's structure (e.g. schema) and of relationships between the tables contained in the database. A user might access a data dictionary to learn about the database and its tables. Without previous knowledge of the database or access to a data dictionary, it may be difficult if not impossible to write specific queries to access data from the database.

### BRIEF DESCRIPTION OF THE DRAWINGS

FIG. 1 is a block diagram of a system according to some embodiments.

FIG. 2 is a database table relationship diagram.

FIG. 3 is a block diagram of a method according to some embodiments.

### DETAILED DESCRIPTION

The several embodiments described herein are solely for the purpose of illustration. Embodiments may include any currently or hereafter-known versions of the elements described herein. Therefore, persons in the art will recognize from this description that other embodiments may be practiced with various modifications and alterations.

The present application presents a design for creation of SQL queries from a combination of metadata elements. The metadata elements are created by breaking up components of a SQL statement for pre-defined template queries and storing the sub-components as metadata elements in a repository.

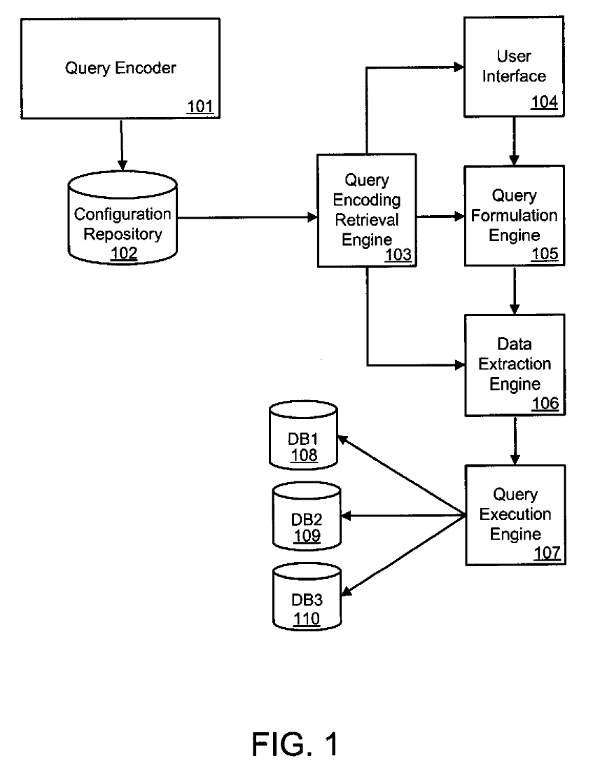

Referring now to FIG. 1, an embodiment of a system 100 is illustrated. In some embodiments, the system 100 may generate and execute ad-hoc queries associated with data spanning multiple data sources. The system 100 may comprise a query encoder 101, a configuration repository 102, a query encoding retrieval engine 103, a user interface 104, a query formulation engine 105, a data extraction engine 106, a query execution engine 107, and one or more databases such as illustrated first database 108, second database 109, and third database 110.

In some embodiments, the query encoder 101 may transform or convert one or more SQL queries into one or more metadata elements. The query encoder 101 may also transform a database schema into a plurality of metadata elements, where each element may describe an individual query aspect such as a table relationship, a JOIN statement, a SELECT statement, a WHERE clause, a FROM clause, etc. The metadata elements created by the query encoder 101 may be stored in the configuration respositiory 102. In some embodiments, the query encoder 101 may configure a preexisting query into metadata elements as well as add, delete, and update metadata elements already stored in the configuration repository 102.

The configuration repository 102 may comprise a plurality of logical relational table objects that define a database schema. The configuration repository 102 may store metadata elements of frequently-used SQL queries, including queries that span multiple databases and/or databases that reside in separate database systems. Specifically, the configuration repository 102 may store metadata elements about two types of queries: single domain queries and cross domain queries. In some embodiments, a single domain query may be a query that targets a specific schema defined in a specific database instance. For example, a single domain query may target a specific category of data such as Statistical Process Control data, Excursion protection data, etc. In some embodiments a data domain or domain may refer to a database schema defined in a particular database system.

A cross domain query may target a combination of one or more single domain queries. The cross domain query may enable integrated access to data from multiple disparate schemas residing in physically distributed and heterogeneous database systems, as well as correlation of data residing in different domains (e.g. different specific categories of data such as Excursion Protection data in relation to Entity Attributes data). A cross domain query may be specified to include arbitrary subsets of data domains, and from each domain included, an arbitrary SQL single domain query belonging to that domain.

In some embodiments, the configuration repository 102 may store metadata elements associated with an application, user-specific configurations associated with the application, and global and user-specific favorite query specifications.

In some embodiments, the configuration repository 102 may comprise the following tables:

| Table Name | Description |
|---|---|
| MC_Q_QUERY | Contains metadata about a single or cross |
| | domain query in the system, e.g. query |
| | name and owning application and user, |
| | data domain it belongs to, and granularity |
| MC_Q_RELATIONLABEL | For a given query (QueryID), the set of |
| | relations (RelationIDs) associated with |
| | that query; A relation for a query is simply |
| | a specification of a set of table join |
| | conditions, and a set of dynamic where |
| | clause conditions; A query may have |
| | multiple relations associated with it |
| MC_Q_QUERY_DISPLAY | Stores metadata about fields in the |
| | SELECT clause of a query, e.g. field |
| | name, database table name, display order, |
| | Order By flag, Field Alias, etc. A query |
| | may have a single set of SELECT clause |
| | fields |
| MC_Q_QUERY_DETAILS | For a cross domain query, each pair of |
| | domains involved in the query have an |
| | associated relation (RelationID) defined in |
| | this object; For a cross domain query Q, a |
| | pair of domains (d1, d2) in Q, the Relation |
| | ID of (d1, d2) under Q is used to define the |
| | set of cross domain conditions for |
| | correlating data returned by the domain |
| | queries of d1, and d2. The cross domain |
| | correlation conditions are defined in |
| | MC_D_QUERY_TABLEJOINS. |
| | The single domain query may be handled |
| | as a special case of the cross domain |
| | query; For a single domain query Q, from |
| | domain d the only pair of domains |
| | involved are (d, d), and hence there may be |
| | a single RelationID defined for query Q. |
| MC_D_QUERY_TABLEJOINS | Contains the metadata about the table join |
| | conditions (for a single domain query), |
| | and the cross domain correlation |
| | conditions for a cross domain query; |
| MC_Q_QUERY_STATIC_FILTERS | Contains Metadata about a subset of |
| | WHERE clause conditions of a single |
| | domain query; the conditions specified |
| | (here are so called static filter conditions); |
| | the value of the right hand operand of a |
| | static filter condition is typically |
| | determined statically at query |
| | specification time, as opposed to at query |
| | execution time; In principle the schema |
| | supports multiple sets of join conditions |
| | for a single domain query, that are |
| | distinguished via a static filter ID, This |
| | enables support of multiple distinct sets of |
| | static filter conditions for the same single |
| | domain query |
| MC_D_QUERY_DYNAMIC_FILTERS | Contains metadata about WHERE clause |
| | dynamic filter conditions; a dynamic filter |
| | condition is a WHERE clause filter |
| | condition such that the right hand operand |
| | (value of the condition) is specified based |
| | on user input received at query execution |
| | time. |
| | The schema supports specification of: |
| | 1. simple conjunctions of conditions (C1 |
| | AND C2 AND C3 . . . ), or disjunction of |
| | conditions, e.g. (C1 OR C2 OR C3 . . . )or a |
| | combination thereof |
| | 2. Disjunction of Conjunctions of arbitrary |
| | length, e.g. (C11 AND C21 AND C31 . . . ) |
| | OR (C12 AND C22 AND C32 . . . ) . . . OR |
| | (C1n AND C2n AND C3n) |
| | 3. Conjunction of Disjunctions of |
| | arbitrary length, e.g. (C11 OR C21 OR |
| | C31 . . . ) AND (C12 OR C22 OR C32 . . . ) . . . |
| | AND (C1n OR C2n OR C3n) |
| MC_Q_JOINED_QUERY_DETAILS | For a given cross domain query at a given |
| | granularity this object contains a reference |
| | to a single domain query from each |
| | domain defined to be included in that |
| | cross domain query. The returned results |
| | from these single domain queries will be |
| | correlated to generate the cross domain |
| | query result |
| MC_D_DATABASES | A reference table for metadata about all |
| | data sources from which data can be |
| | retrieved, and the associated home site for |
| | each source |
| MC_D_DOMAINS | A reference table for metadata about data |
| | domains contained in the data sources |
| MC_D_DB_FIELDS | Contains a reference to each field from |
| | each table that has appeared in any single |
| | domain query from any domain in the |
| | system |

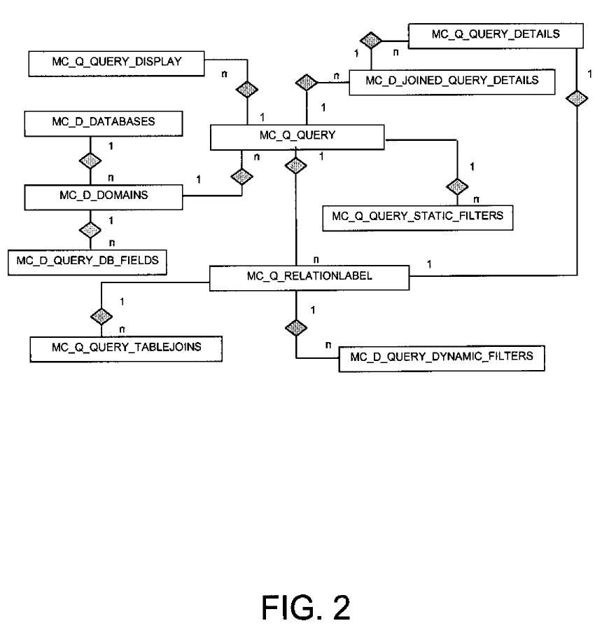

Each table may have a specific relationship with one or more other tables in the configuration repository 102. One embodiment of the relationship between the tables is illustrated in FIG. 2. Some tables may have a 1 to 1 relationship and some tables may have a 1 to many relationship as known in the art.

The query encoding retrieval engine 103 is to retrieve data from the configuration repository 102 and is to send the data to the user interface 104, the query formulation engine 105, and/or the data extraction engine 106. In some embodiments, the data may comprise one or more template queries, user preferences, and/or query metadata elements. The query encoding retrieval engine 103 may be responsible for retrieving query metadata elements to display in the user interface 104 and may support the SQL query generation from a query specification. In some embodiments, the query specification may be written in an Extensible Markup Language (“XML”).

The user interface 104 may allow a user to select from a plurality of template queries stored in the configuration repository 102 via the query encoding retrieval engine 103. The user interface 104 may also permit a user to input desired fields and other conditions into a template query that are currently not included in the template query. When a result of a query is presented to a user, the user may modify the query via the user interface 104. Since knowledge of a database schema may be required for query creation, the use of one or more templates that define queries associated with each data domain and the identification of one or more cross domain joins may allow for queries to be generated without having to manually associate data from different domains.

The user interface 104 may dynamically prune or modify a returned result of a query. In one example, a WHERE clause may be modified to receive its value from user inputs at run time. Alternatively, the clause may be passed a value in an Input Data Set from the application where parameters associated with the Input Data Set are stored in the configuration repository 102.

A value assigned to a condition in a WHERE clause may vary at run time by skipping (e.g. not formulating as part of the SQL statement for an execution of the query), by passing a system level token as the value of the column along a path that is dynamically selected by a user from a hierarchical structure (e.g. a domain tree) of parameter values associated with a specific domain of the query. A value corresponding to a given WHERE clause condition may be a leaf level number (e.g. a number of steps to climb from the leaf level to reach the value sought). When a user modifies a query vie the user interface 104, the application may prune or modify the domain tree restricting it to the paths along which user selection occurred. By using a location specification in the configuration repository 102 for a condition and given a passed tree, the passed tree may be navigated to obtain the value for the WHERE clause condition.

The query formulation engine 105 may generate a specification associated with a query. The specification may define a single domain query or a cross domain query. The query specification is defined by the metadata elements stored in the configuration repository 102 and any additional attributes passed from the user interface 104 at run time. In some embodiments, the query formulation engine 105 may transform a query defined in a template query and user selected attributes into datasets (e.g. .NET datasets retrieved from a .NET based user interface) to define the query specification. In some embodiments the specification may be written in XML.

The data extraction engine 106 may receive a query specification from the query formulation engine 105. In some embodiments the data extraction engine 106 may receive the query specification via an XML based interface. The data extraction engine 106 may formulate SQL code based on the query specification. The SQL query may span one or more target data sources as defined in the query specification. Each template query may be customized and may be related to either a single domain query or a cross domain query. Once the actual SQL code associated with the SQL query is generated, the generated SQL code may have little resemblance to the template query used to create the specification because the generated query is defined by user inputs and the runtime determination of appropriate join conditions.

The data extraction engine 106 may submit the formulated SQL code to the query execution engine 107. The query execution engine 107 executes the generated query against one or more data sources such as 108, 109, and 110 and returns the result to a user via the user interface 104. The query execution engine 107 may comprise any product or system to access one or more databases.

The first database 108, the second database 109, and third database 110 may each comprise any relational database system that is or becomes known. More specifically, each of databases 108, 109 and 110 may comprise any relational database system provided by vendor or vendors.

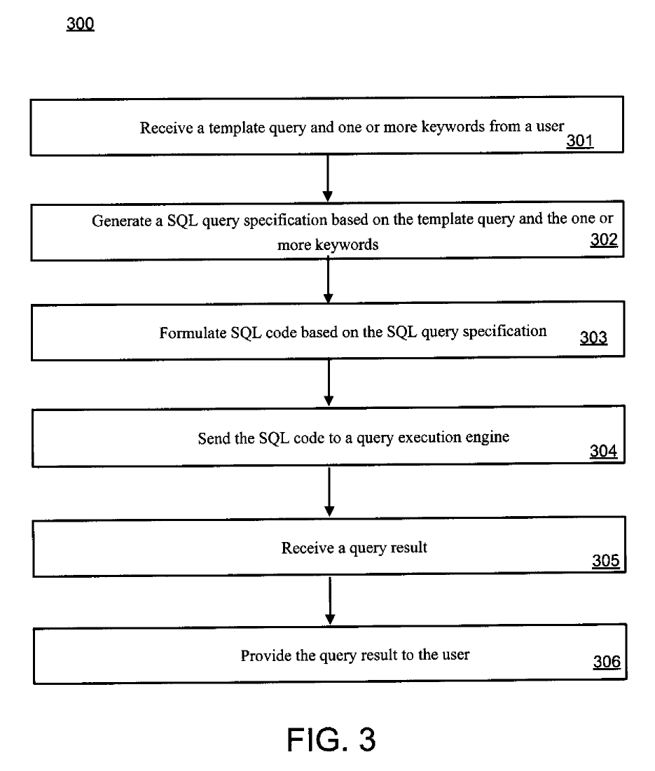

Now referring to FIG. 3, an embodiment of a method 300 is illustrated. Method 300 may be executed by any combination of hardware, software, and firmware, including but not limited to, the system 100 of FIG. 1. Some embodiments of method 300 may facilitate query generation.

At 301 a template query and one or more keywords are received from a user. A user may select a template query via a listing of template queries presented at a user interface 104. The template query may be a predefined query that comprises a plurality of database elements. For example, the template query may define a simple query that is frequently used to extract data from a one or more data sources. A user may add additional keywords or criteria to the template query. A keyword may comprise additional elements such as, but not limited to, additional data elements, order by clauses, sort by clauses, and where clauses.

For illustrative purposes, and to aid in understanding features of the some embodiments, an example will now be introduced. This example is not intended to limit the scope of the appended claims.

A template query may define a query to produce items X, Y and Z from table A and table B. A user may also want to compare items X, Y, and Z with an item M. The user may not know which table comprises item M (e.g. table C) nor does the user know how to join table A and table B with table C.

Next, at 302, a SQL query specification is generated based on the template query and the one or more keywords. In some embodiments, generation of the query specification may comprise receiving data from a configuration repository where the data is associated with the template query and the one or more keywords. The configuration repository comprises a plurality of tables and each table comprises metadata associated with one or more databases. The SQL specification may be formulated and may comprise one or more select statements, one or more join statements, and one or more where statements based on the received data.

Continuing with the above example of 302, a query specification may be created based on the template query and the user input. The specification may contain data (e.g. metadata elements) specifying the tables required to produce the query, the JOIN statements needed to join tables, one or more items to be selected and any conditions specified by one or more WHERE clauses. The specification may further contain information about the items selected (e.g. X, Y, Z, M) and how the items may be compared (e.g. sorted by, ordered by, greater than, less than, etc.).

At 303, SQL code is formulated based on the SQL query specification. The SQL code may be associated with the SQL query specification and may joins two or more tables and in some embodiments the SQL code may join a first table from a first database and a second table from a second database. The SQL code generated based on the SQL query specification may be different than the SQL code associated with the template query.

Continuing with the above example, the specification may be used to create SQL code that comprises all of the elements contained in the SQL query specification. Therefore, the SQL code may comprise a join of table A with table B as well as a join of table A with table C.

At 304, the SQL code is sent to a query execution engine. The SQL code in the created query may be sent to an execution engine to execute the query against one or more databases. With reference to the present example, an SQL query that comprises a select statement for items X, Y, Z, and M may be created and executed at 304. After the query is executed, a query result is received at 305.

The query result is provided to the user at 306. In some embodiments, after a user receives the query result, the user may modify the result to add new fields, change a sort order, change how elements are grouped, etc. and may resubmit the query for processing. Resubmitting may cause generation of a new query specification and in turn newly created SQL code.

Various modifications and changes may be made to the foregoing embodiments without departing from the broader spirit and scope set forth in the appended claims.

What is claimed is:

1. A method comprising:
receiving a template query and one or more keywords from a user;
generating a SQL query specification based on the template query and the one or more keywords;
formulating SQL code based on the SQL query specification;
sending the SQL code to a query execution engine;
receiving a query result; and
providing the query result to the user.

2. The method of claim 1, wherein the generating comprises:
receiving data from a configuration repository, the data associated with the template query and the one or more keywords, wherein the configuration repository comprises a plurality of tables and each table comprises metadata associated with one or more databases; and
wherein the formulating comprises formulating one or more select statements, one or more join statements, and one or more where statements based on the received data.

3. The method of claim 1, wherein the SQL code joins two or more tables.

4. The method of claim 1, wherein the SQL code joins a first table from a first database and a second table from a second database.

5. The method of claim 1, further comprising:
receiving a query modification from the user; and
providing a second query result to the user.

6. The method of claim 5, wherein the query modification comprises an instruction to sort by, order by, or specify criteria.

7. The method of claim 1, wherein the SQL query specification is written in XML.

8. An apparatus comprising:
a processor; and
a computer readable medium storing instructions that when executed by the processor cause the apparatus to perform a method, the method comprising:
receiving a template query and one or more keywords from a user;
generating a SQL query specification based on the template query and the one or more keywords;
formulating SQL code based on the SQL query specification;
sending the SQL code to a query execution engine;
receiving a query result; and
providing the query result to the user.

9. The apparatus of claim 8, wherein the generating comprises:
receiving data from a configuration repository, the data associated with the template query and the one or more keywords, wherein the configuration repository comprises a plurality of tables and each table comprises metadata associated with one or more databases; and
wherein the formulating comprises formulating one or more select statements, one or more join statements, and one or more where statements based on the received data.

10. The apparatus of claim 8, wherein the SQL code joins two or more tables.

11. The apparatus of claim 8, wherein the SQL code joins a first table from a first database and a second table from a second database.

12. The apparatus of claim 8, further comprising instruction to:
receive query modification from the user; and
provide a second query result to the user.

13. The apparatus of claim 12, wherein the query modification comprises an instruction to sort by, order by, or specify criteria.

14. The apparatus of claim 8, further comprising:
a database comprising configuration repository, wherein the configuration repository comprises a plurality of tables, each table comprising metadata associated with one or more databases.

15. The apparatus of claim 8, wherein the SQL query specification is written in XML.
